(19) United States
(12) Patent Application Publication
(10) Pub. No.: US 2025/0375777 A1
(43) Pub. Date: Dec. 11, 2025

(54) FLUID FLOW APPARATUSES AND TOOL FOR MAKING THE SAME

(71) Applicant: Dan Hastings, III, Laredo, TX (US)

(72) Inventor: Dan Hastings, III, Laredo, TX (US)

(21) Appl. No.: 18/737,208

(22) Filed: Jun. 7, 2024

(51) Int. Cl. B05B 1/14

(52) U.S. Cl. CPC B05B 1/14

(57) ABSTRACT

A fluid dispensing apparatus for dispensing fluid from a bottle includes a cap with a top wall and a perimeter wall. The perimeter wall is coupled to and extends away from the top wall. The top wall defines a plurality of holes which extend through the top wall, and the perimeter wall has internal threads shaped to engage external threads of the bottle. A perforation tool is disclosed for forming a fluid dispensing apparatus by perforating a cap. The tool includes a collar which clamps to the bottle, a cutting member for perforating the cap, and a lever to actuate the cutting member.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fluid dispensing apparatuses and more particularly pertains to a new fluid dispensing apparatus for dispensing fluid from a bottle.

### (2) Description of Related Art Including Information Disclosed Under 37 CFR 1.97 and 1.98

The prior art describes myriad shower head fixtures but fails to describe a cap for attaching to a bottle and dispensing water through holes in the cap.

### BRIEF SUMMARY OF THE INVENTION

An embodiment of the disclosure meets the needs presented above by generally comprising a cap with a top wall and a perimeter wall. The perimeter wall is coupled to and extends away from the top wall. The top wall defines a plurality of holes which extend through the top wall, and the perimeter wall has internal threads shaped to engage external threads of a bottle.

Another embodiment of the disclosure includes a perforation tool for forming a fluid dispensing apparatus by perforating a cap. The tool comprises a collar, a lever, and a cutting member. The collar has an interior dimension sized to extend around a neck of a bottle. The lever is coupled to the collar and comprises an arm which is movable alternately toward and away from the collar. The cutting member is coupled to the arm of the lever and comprises a plurality of spikes which point toward the collar.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fluid dispensing apparatus according to an embodiment of the disclosure.

FIG. 2 is a bottom perspective view of an embodiment of the disclosure.

FIG. 3 is a cross section view of an embodiment of the disclosure taken from Arrows 3-3 in FIG. 1.

FIG. 4 is a top perspective view of an embodiment of the disclosure with a cover in a closed position.

FIG. 5 is a top perspective view of an embodiment of the disclosure with a cover in an open position.

FIG. 6 is a cross section view of an embodiment of the disclosure taken from Arrows 6-6 in FIG. 4.

FIG. 7 is a top perspective view of an embodiment of the disclosure with a cover in a closed position.

FIG. 8 is a top perspective view of an embodiment of the disclosure with a cover in an open position.

FIG. 9 is a cross section view of an embodiment of the disclosure taken from Arrows 9-9 in FIG. 7.

FIG. 10 is a top perspective view of an embodiment of the disclosure with a cover in an aligned position.

FIG. 11 is a top perspective view of an embodiment of the disclosure with a cover in a covered position.

FIG. 12 is a top view of an embodiment of the disclosure.

FIG. 13 is a cross section view of an embodiment of the disclosure taken from Arrows 13-13 in FIG. 11.

FIG. 14 is an exploded perspective view of a perforation tool of an embodiment of the disclosure.

FIG. 15 is a perspective view of an embodiment of the disclosure.

FIG. 16 is a perspective in-use view of an embodiment of the disclosure.

FIG. 17 is a side in-use view of an embodiment of the disclosure.

FIG. 18 is a perspective in-use view of a fluid dispensing apparatus formed by a perforation tool of an embodiment of the disclosure.

FIG. 19 is a perspective in-use view of a fluid dispensing apparatus formed by a perforation tool of an embodiment of the disclosure.

FIG. 20 is a perspective exploded view of an embodiment of the disclosure.

FIG. 21 is perspective view of an embodiment of the disclosure depicting a vessel assembly in an inverted position.

FIG. 22 is a perspective view of an embodiment of the disclosure depicting a vessel assembly in an upright position.

FIG. 23 is a perspective view of a fluid-receiving member of an embodiment of the disclosure which shows an actuator in a closed position.

FIG. 24 is a perspective view of a fluid-receiving member of an embodiment of the disclosure which shows an actuator in an open position.

FIG. 25 is a perspective view of a fluid-receiving member of an embodiment of the disclosure.

FIG. 26 is a cross-section view of a fluid-receiving member of an embodiment of the disclosure taken from Line 26-26 in FIG. 23.

FIG. 27 is a cross-section view of a fluid-receiving member of an embodiment of the disclosure taken from Line 27-27 in FIG. 27.

FIG. 28 is a perspective view of an embodiment of the disclosure with a mounting member for attaching a bottle of the embodiment in an inverted position onto a support structure.

FIG. 29 is a side view of an embodiment of the disclosure with a mounting member for attaching a bottle of the embodiment in an inverted position onto a support structure.

### DETAILED DESCRIPTION OF THE INVENTION

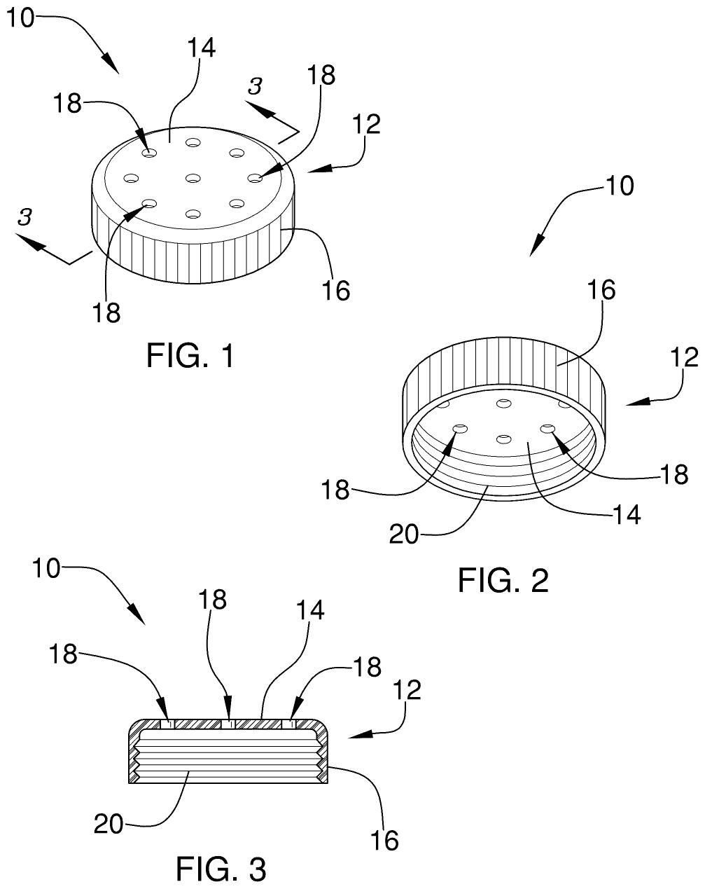

With reference now to the drawings, and in particular to FIGS. 1 through 13 thereof, a new fluid dispensing apparatus embodying the principles and concepts of an embodiment of the disclosure and generally designated by the reference numeral 10 will be described.

As best illustrated in FIGS. 1 through 3, the fluid dispensing apparatus 10 generally comprises a cap 12 with a top wall 14 and a perimeter wall 16. The perimeter wall 16 is coupled to and extends away from the top wall 14. The top wall 14 defines a plurality of holes 18 which extend through the top wall 14. The perimeter wall 16 has internal threads 20 shaped such that the internal threads 20 are configured for engaging external threads (not shown) of a bottle 80.

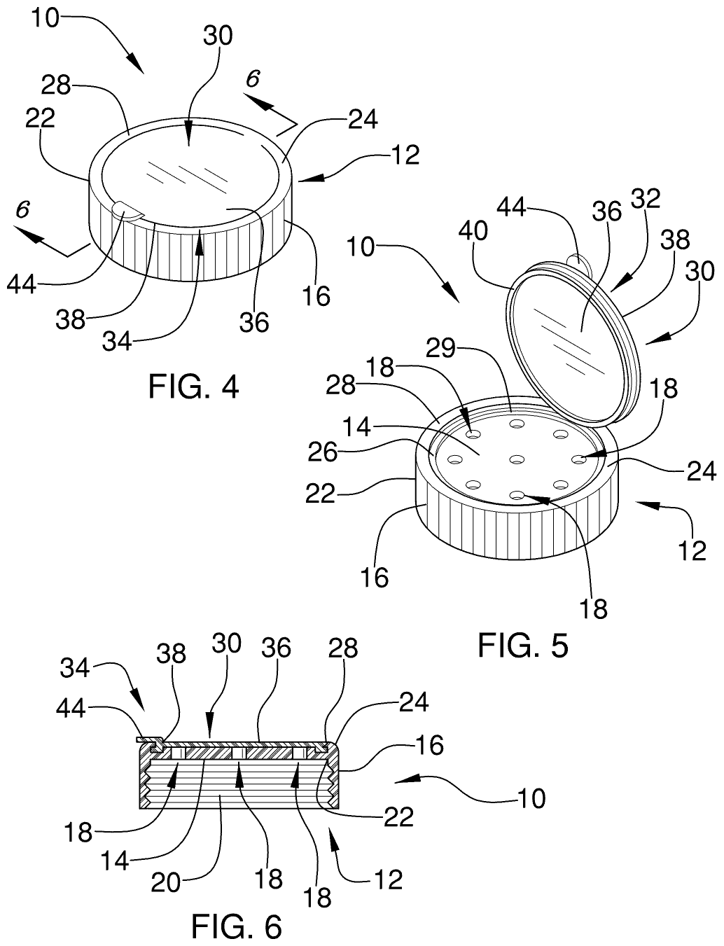

In reference to FIGS. 4 through 6, another embodiment further comprises a lip 24 and a cover 30. The lip 24 is coupled to the top wall 14 of the cap 12 opposite the perimeter wall 16 and extends along a peripheral edge 22 of the top wall 14. The lip 24 has an inset surface 26 which is inset from an upper surface 28 of the lip 24. The inset surface 26 is also positioned inwardly from the upper surface 28. The cover 30 is pivotally coupled to the lip 24 and is movable between an open position 32 and a closed position 34 with respect to the plurality of holes 18 of the top wall 14. The cover 30 forms a seal with the lip 24 when the cover 30 is in the closed position 34. The cover 30 comprises a panel 36, a ring 40, and a tab 44. The ring 40 is coupled to and extends away from the panel 36 and is complementary in shape to an interior surface 29 of the lip 24. The tab 44 is coupled to and extends away from an exterior edge 38 of the panel 36. When the cover 30 is in the closed position 34, the panel 36 lies against the inset surface 26 of the lip 24 and the ring 40 is positioned in the lip 24.

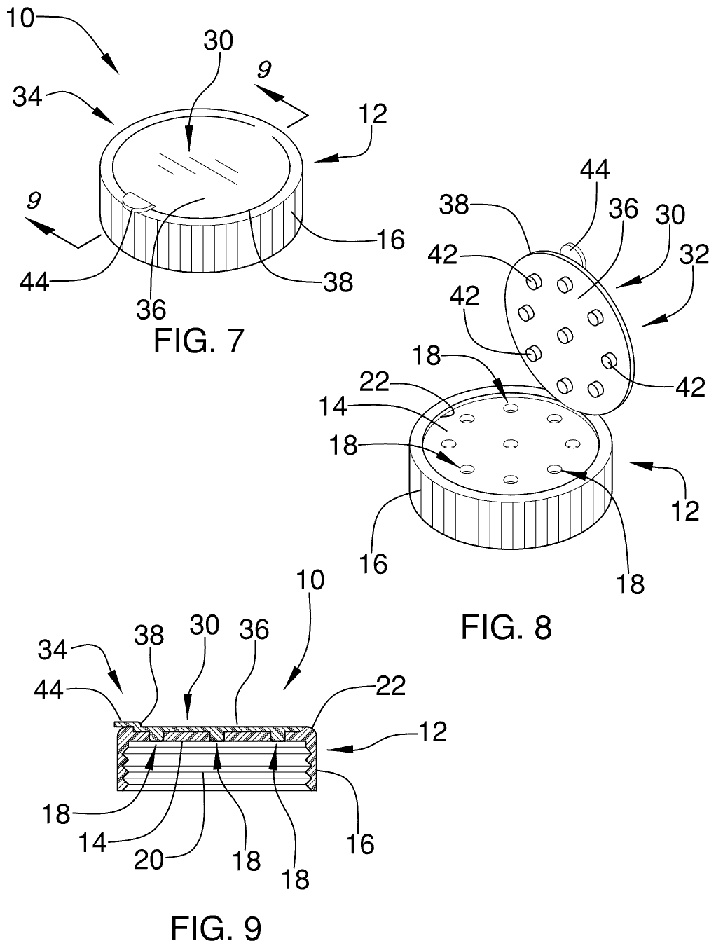

FIGS. 7 through 9 illustrate yet another embodiment, which further comprises a lip 24 and a cover 30. The lip 24 is coupled to the top wall 14 of the cap 12 opposite the perimeter wall 16 and extends along a peripheral edge 22 of the top wall 14. The cover 30 is pivotally coupled to the lip 24 and is movable between an open position 32 and a closed position 34 with respect to the plurality of holes 18 of the top wall 14. The cover 30 forms a seal with the lip 24 when the cover 30 is in the closed position 34. The cover 30 comprises a panel 36 and a plurality of protrusions 42 coupled to the panel 36. The plurality of protrusions 42 extend away from the panel 36 and plug the holes 18 of the top wall 14 of the cap 12 when the cover 30 is positioned in the closed position 34. The cover 30 also includes a tab 44 which is coupled to and extends away from an exterior edge 38 of the panel 36.

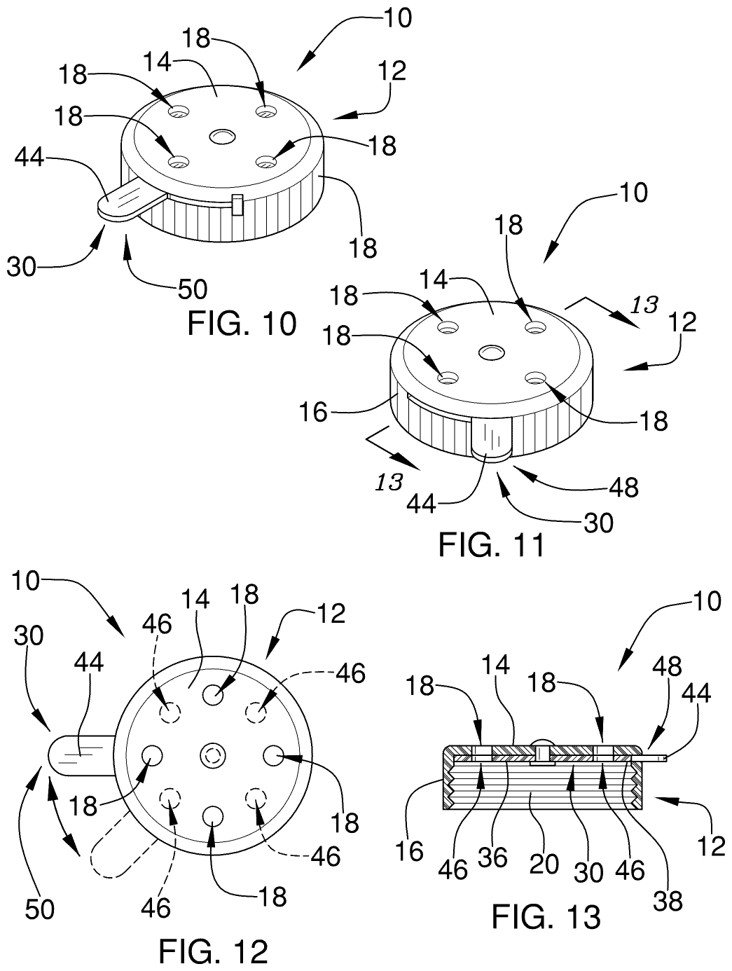

In reference to FIGS. 10 through 13, a further embodiment comprises a cover 30 which is rotatably coupled to the top wall 14. The cover 30 comprises a panel 36 which defines a plurality of aperture 46. The cover 30 is positionable in an aligned position 48 wherein the plurality of aperture 46 aligns with the plurality of holes 18 of the top wall 14 of the cap 12. The cover 30 is also positionable in a covered position 50 wherein the panel 36 forms a seal with the top wall 14 of the cap 12 and the plurality of aperture 46 is unaligned with the plurality of holes 18 of the top wall 14. The cover 30 further includes a tab 44 which is coupled to and extends away from an exterior edge 38 of the panel 36. A stop 52 is coupled to the cap 12 and is positioned along a path of movement of the tab 44 such that the stop 52 obstructs the tab 44 to prevent the cover 30 from is positioned in the aligned position 48. The stop 52 is configured to be torn from the cap 12 and discarded to permit the cover 30 to move into the aligned position 48. The stop 52 is integrally formed with the cap 12, and the stop 52 and the cap 12 comprise a plastic. Other materials may be suitable to form the stop 52 and the cap 12. In some embodiments, the stop 52 may be coupled to the cap 12 using a linking material that may be torn by a user. In yet other embodiments, the stop 52 also may be movably coupled to the cap 12 such that the stop 52 may be moved alternately into and out of the path of movement of the tab 44.

In use, the above embodiments of the fluid dispensing apparatus 10 screw onto the bottle 80 and permit a fluid stored in the bottle 80 to exit through the plurality of holes 18. The fluid may be emitted in a shower spray pattern. It is a purpose of the present invention to limit a flow rate of the fluid as it flows from the bottle 80 as compared to the fluid pouring 40 out of the bottle 80 without the fluid dispensing apparatus 10 attached to the bottle 80, thereby conserving fluid stored in the bottle 80.

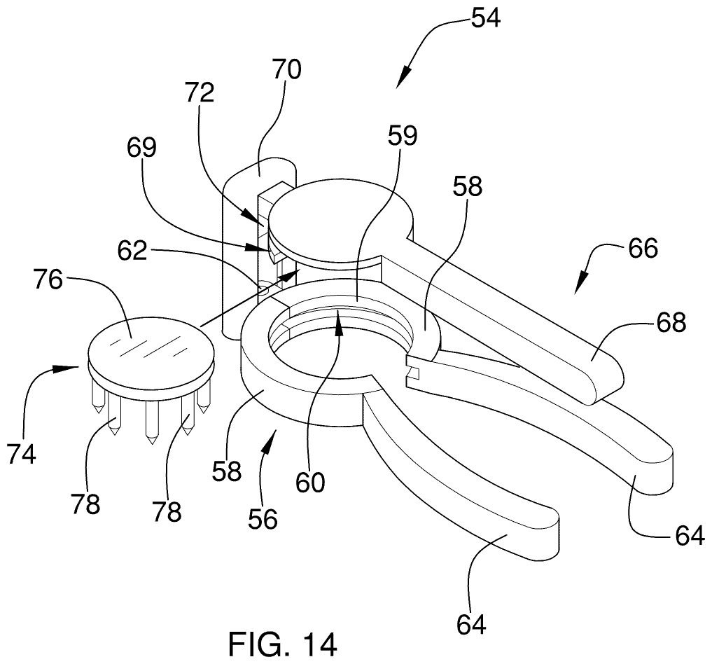

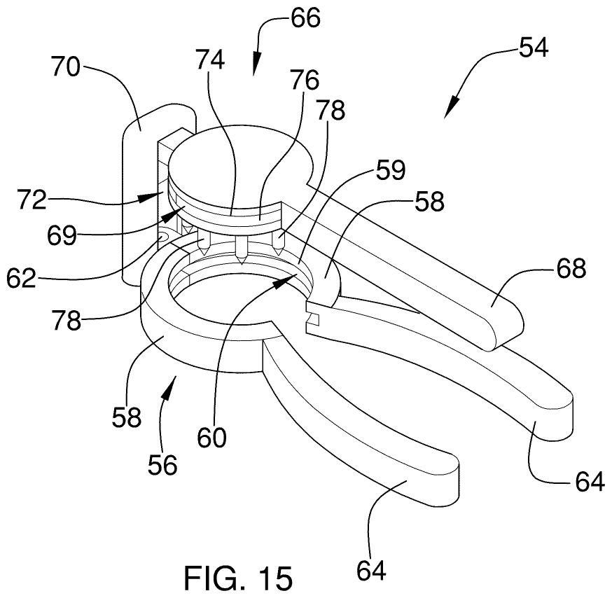

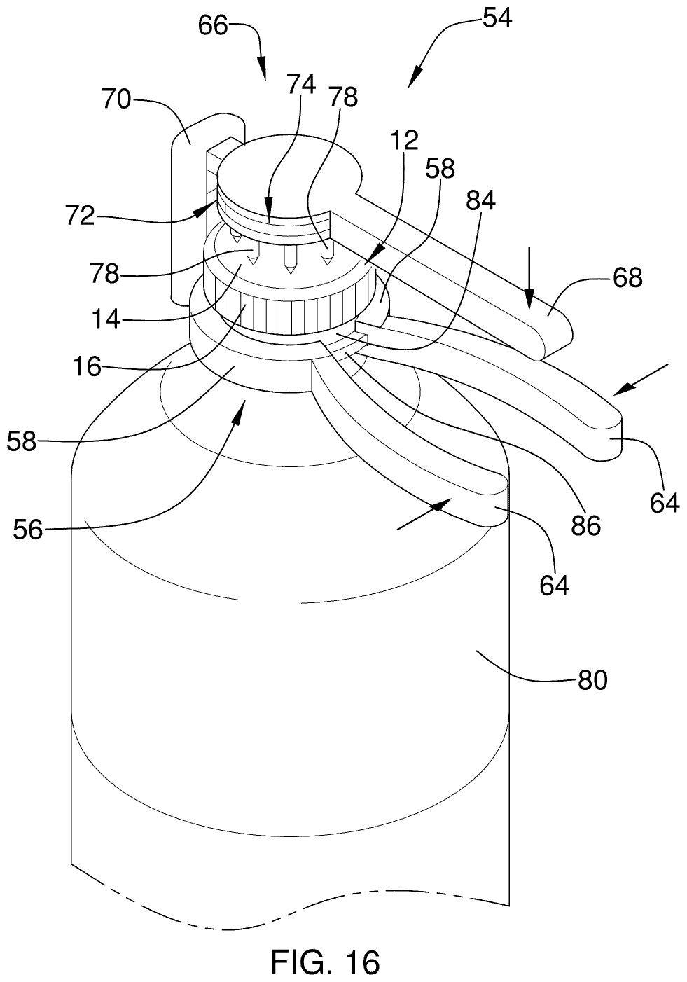

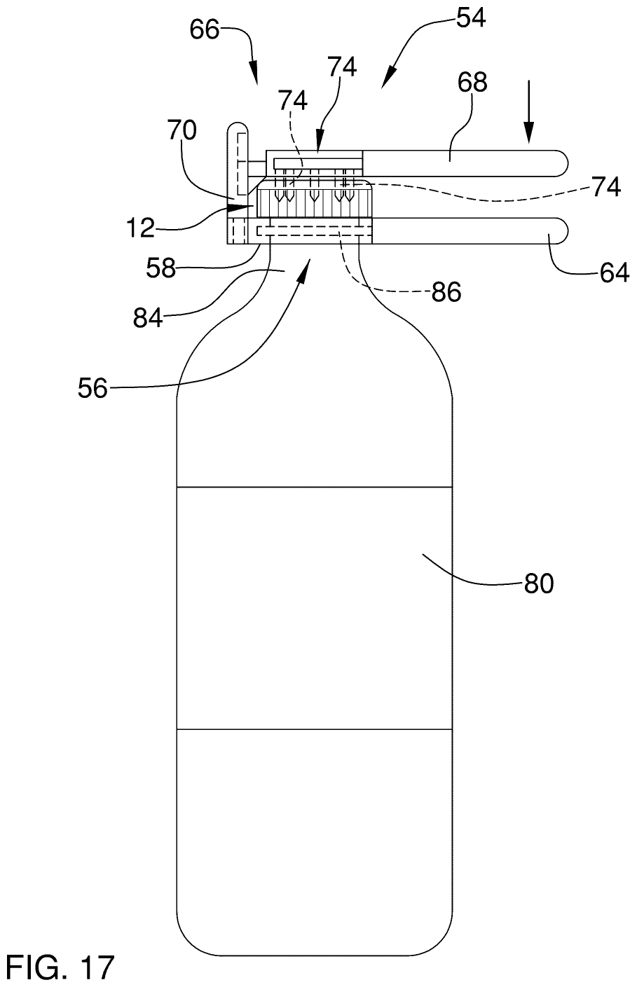

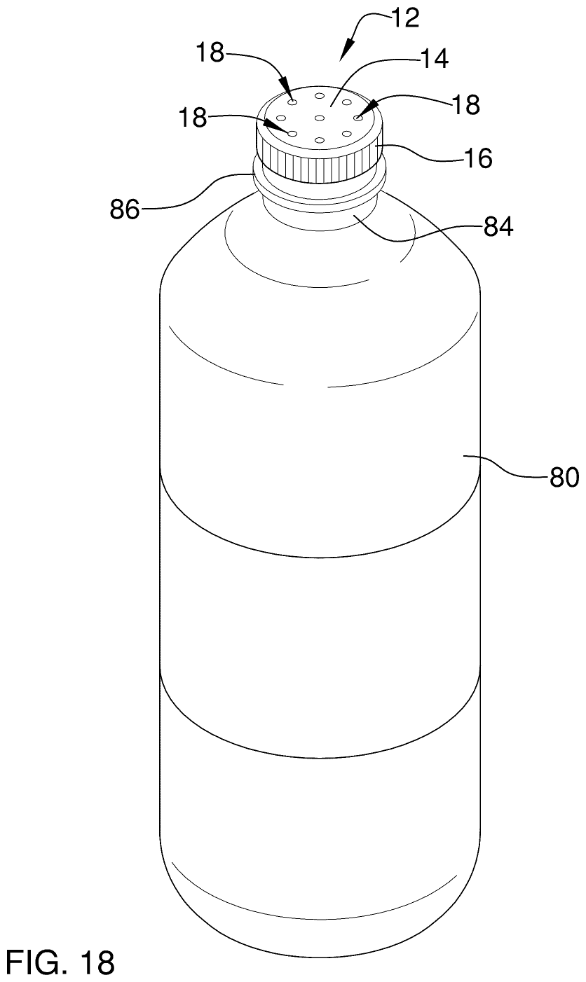

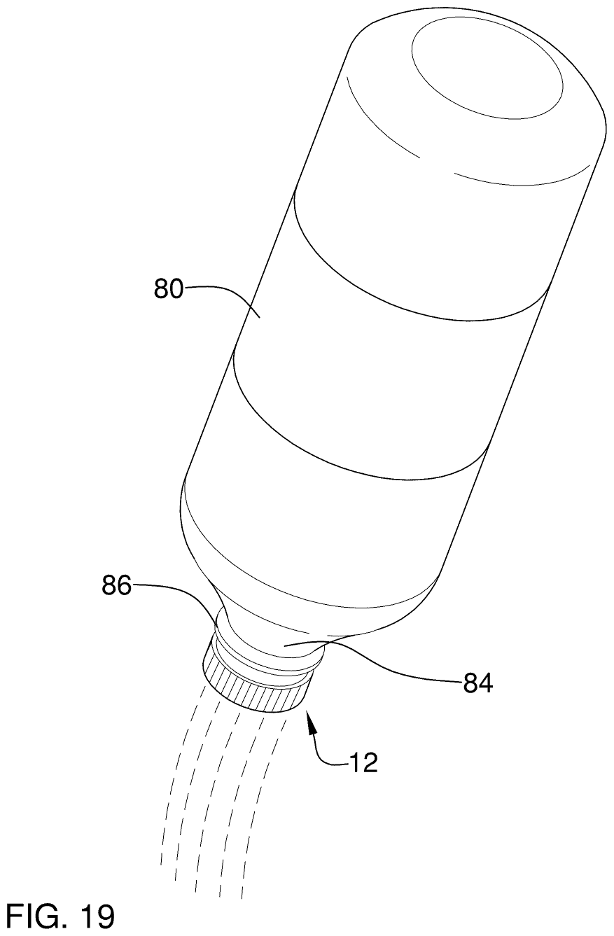

Another embodiment of the present invention comprises a perforation tool 54 for forming a fluid dispensing apparatus 10 by perforating a cap 12. The perforation tool 54 is depicted in FIGS. 14 through 19. The perforation tool 54 comprises a collar 56 with an interior dimension such that the collar 56 is configured to extend around a neck 84 of a bottle 80. A lever 66 is coupled to the collar 56 and comprises an arm 68 which is movable alternately toward and away from the collar 56. A cutting member 74 is coupled to the arm 68 of the lever 66 and comprises a plurality of spikes 78 which point toward the collar 56.

The collar 56 comprises a pair of segments 58 which are pivotally interconnected. Each one of a pair of handles 64 is attached to an associated one of the pair of segments 58 opposite a pivot 62 of the collar 56 so that the segments 58 may be moved alternately toward and away from each other to clamp and release the bottle 80 respectively, via the handles 64. The collar 56 also defines a groove 60 in an interior side 59 of the collar 56 which has a size such that the groove 60 is configured to receive an outwardly protruding ridge 86 of the bottle 80.

The lever 66 further comprises a track 70 which is coupled to the collar 56 and is slidably coupled to the arm 68. The track 70 defines a channel 72 through which the arm 68 is slidable to move the arm 68 relative to the collar 56. In other embodiments, the arm 68 may be pivotable with respect to the collar 56. The cutting member 74 is removable from the arm 68 and further comprises a disc 76 to which the spikes 78 are attached. The arm 68 forms a bay 69 for receiving the disc 76, and the plurality of spikes 78 point toward the collar 56 when the cutting member 74 is coupled to the arm 68.

In use, the perforation tool 54 attaches to the bottle 80 via the collar 56 while the cap 12 is attached to the bottle 80. The collar 56 receives the protruding ridge 86 of the bottle 80 into the groove 60 and clamps to the bottle 80 via moving the handles 64 toward each other. The cap 12 is thereby positioned above the collar 56 and secured relative to the perforation tool 54. The lever 66 is moved toward the collar 56 while the cutting member 74 is held in the bay 69, thereby urging the spikes 78 into and through the top wall 14 of the cap 12 and forming the fluid dispensing apparatus 10.

The perforation tool 54 also may have a plate attached or attachable to the collar 56 such that the plate may be used to support the cap 12 during 40 use of the perforation tool 54. In such an embodiment, the perforation tool 54 would be operable to perforate the cap 12 and form the fluid dispensing apparatus 10 without using the bottle 80 to support the cap 12. Instead, the cap 12 would be supported on the plate, retained on the plate via the collar 56, and perforated by the spikes 78 as the lever 66 is moved toward the collar 56 with the cutting tool 54 attached.

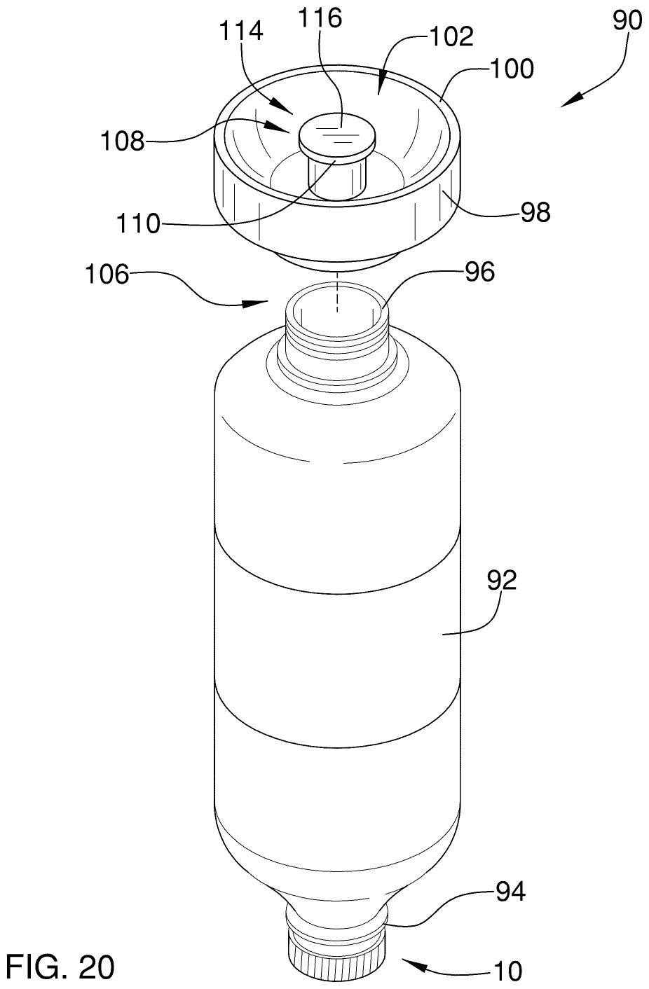

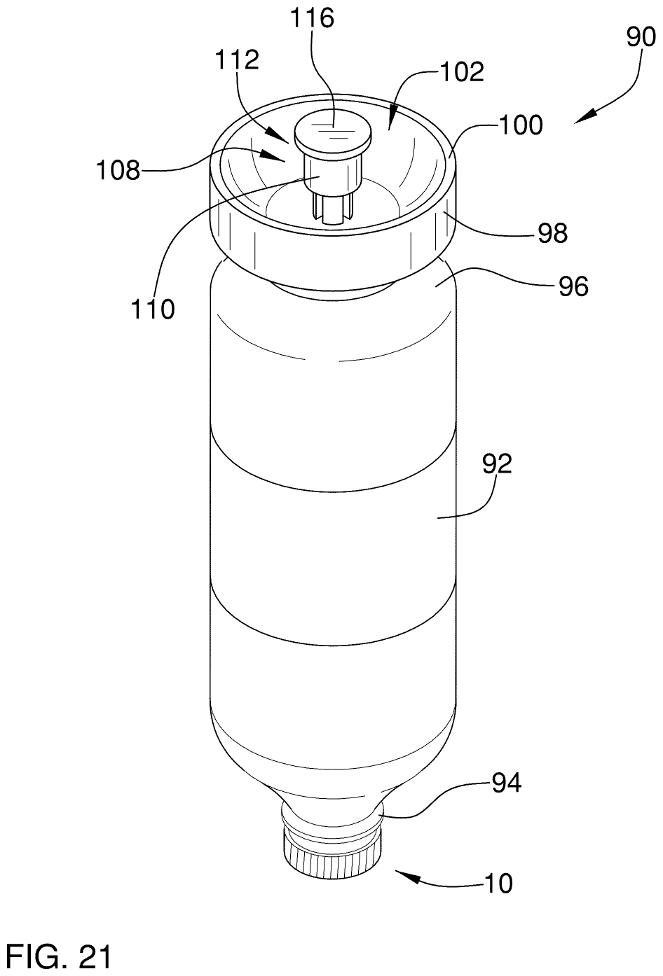

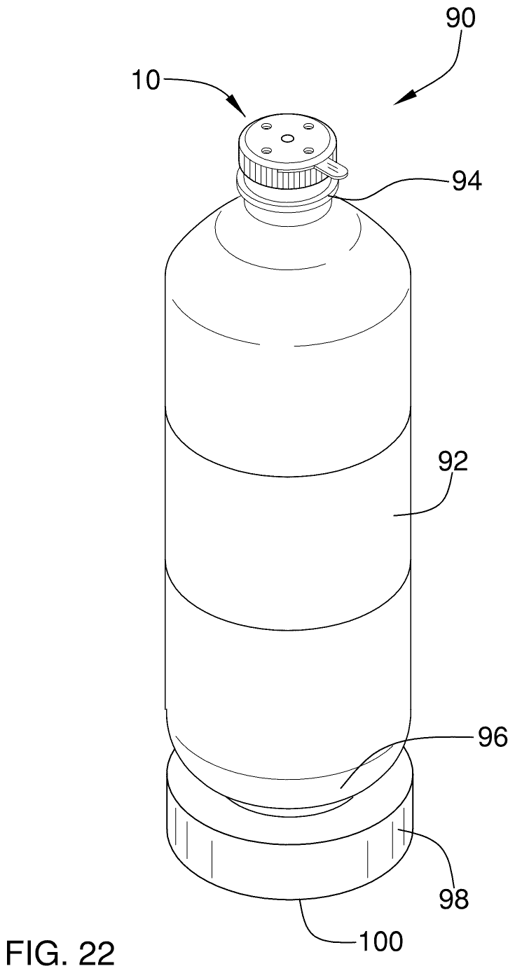

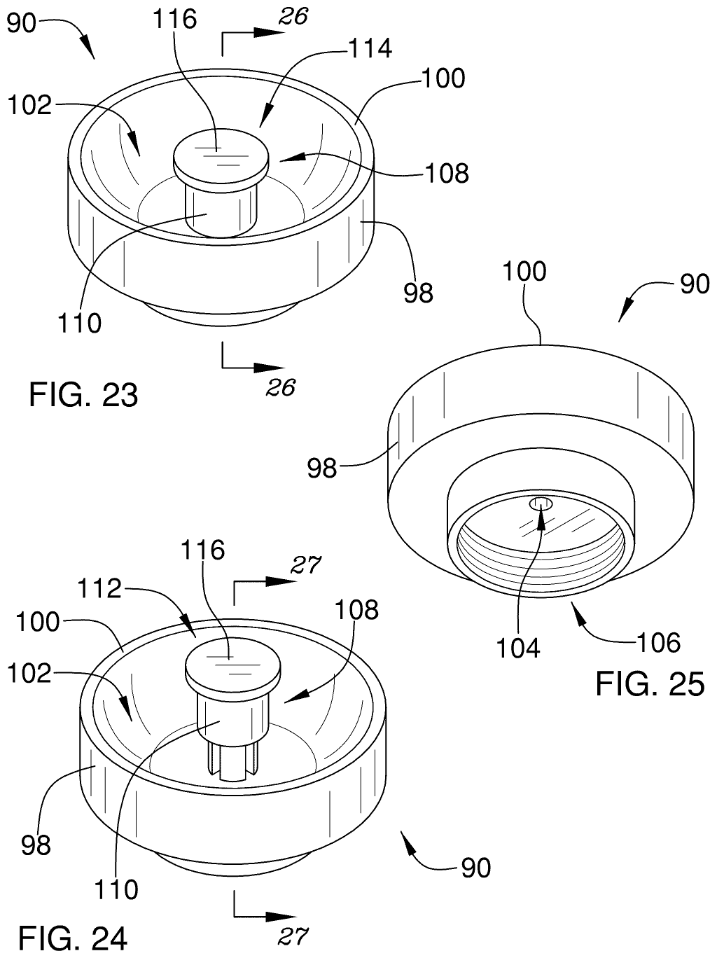

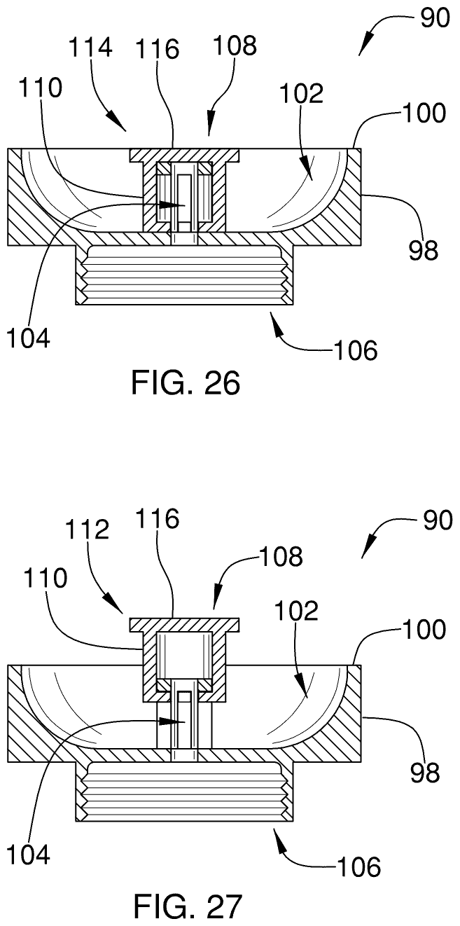

With reference to FIGS. 20 through 27, another embodiment of the present disclosure is depicted which comprises a vessel assembly 90 for containing and dispensing a fluid. The vessel assembly 90 includes a bottle 92 which defines an interior space therein for containing the fluid. The bottle 92 has a top end 94 and a bottom end 96, each of which is open to the interior space. The fluid-dispensing apparatus 10 shown in FIGS. 10 through 13 is depicted as being attached to the top end 94 of the bottle 92. Other embodiments of the fluid-dispensing apparatus 10 or other fluid-dispensing nozzles also may be attached to the top end 94 of the bottle 92 to facilitate dispensing fluid from the bottle 92.

A fluid-receiving member 98 is removably mounted to the bottom end 96 of the bottle 92. The fluid-receiving member 98 has a lower end 100 which faces away from the bottle 92 when the fluid-receiving member 98 is attached to the bottle 92. A basin 102 is defined in the lower end 100 of the fluid-receiving member 98 and a channel 104 fluidly couples the basin 102 to the interior space of the bottle 92 when the fluid-receiving member 98 is mounted to the bottle 92. A threaded coupling 106 removably attaches the fluid-receiving member 98 to the bottle 92.

A valve 108 is mounted to the fluid-receiving member 98 and is positioned in the channel 104. The valve 108 is configured to selectively permit fluid to pass between the basin 102 of the fluid-receiving member 98 and the interior space of the bottle 92. The valve 108 has an actuator 110 which is movable between an open position 112 and a closed position 114 to alternately open and close the valve 108 respectively. A bottom side 116 of the actuator 110 is positioned coplanar to the lower end 100 of the fluid-receiving member 98 when in the closed position 114, and the actuator 110 protrudes away from the bottle 92 past the lower end 100 of the fluid-receiving member 98 when in the open position 112.

In use, fluid may be selectively dispensed through the fluid-dispensing apparatus 10. When the fluid-receiving member 98 is attached to the bottom end 96 of the bottle 92, the bottle 92 may be inverted such that fluid may be poured into the interior space of the bottle 92 via the basin 102 and channel 104 of the fluid-receiving member 98. Placing the bottle 92 in an upright position on a planar support surface causes the actuator 110 to be pressed against the planar support surface such that the actuator 110 moves to the closed position 114.

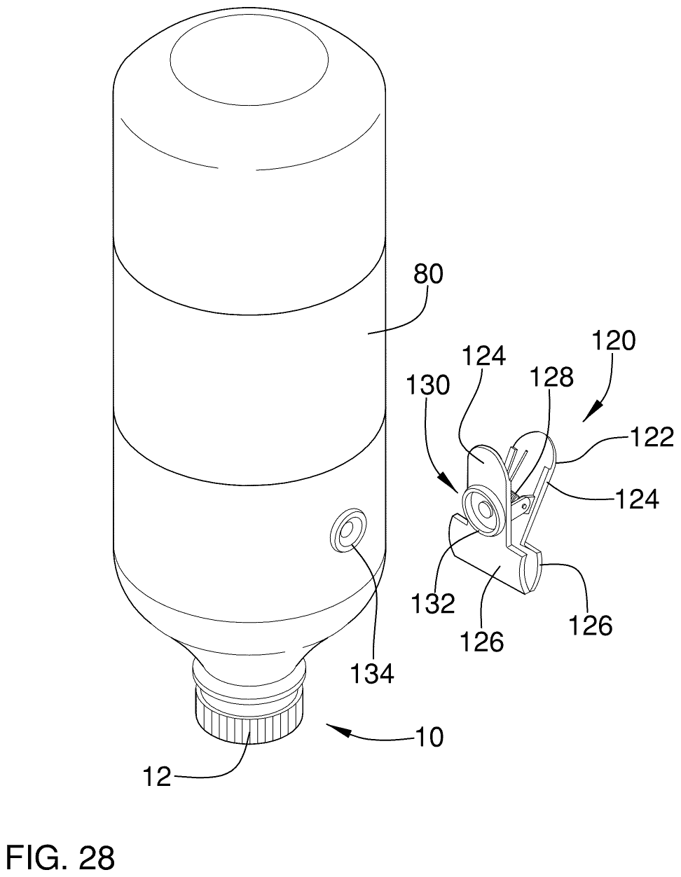

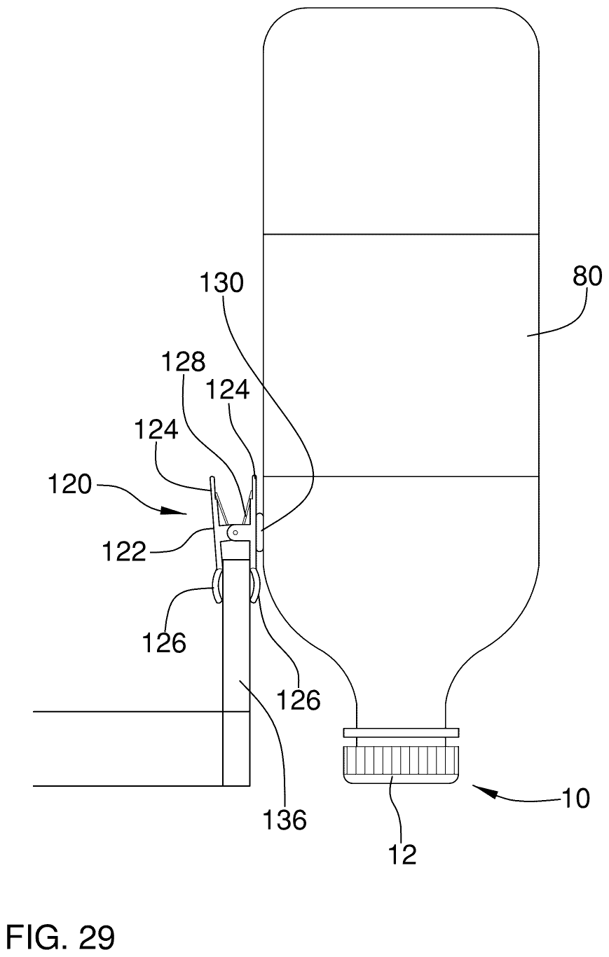

With reference to FIGS. 28-29, a mounting member 120 may be implemented which may be used to mount the bottle 80 to a support structure 136 in an inverted position such that fluid may be dispensed via gravity through the cap 12. The mounting member 120 shown comprises a clip 122 having two levers 124 pivotally attached to each other and two jaws 126, wherein each jaw 126 is mounted to an end of an associated one of the levers 124. The levers 124 are biased via a torsion spring 128 or the like to urge the jaws 126 toward each other to clamp onto the support structure 136. A connector 130 is provided and has a first mating member 132 attached to the clip 122 and a second mating member 134 attached to the bottle 80. The first and second mating members 132, 134 are selectively joinable to attach the clip 122 to the bottle 80. The connector 130 is a snap button, wherein the first and second mating members 132, 134 have generally cylindrical mating surfaces, which may allow the bottle 80 to pivot with respect to the clip 122. In this manner, the clip 122 may be attached in any of a variety of angles with respect to the bottle 80 to the support structure 136. The bottle 80 may also be rotated between an upright position and the inverted position while attached via the clip 122 to the support structure 136. In other embodiments, the connector 130 may comprise a magnet, a hook-and-loop fastener, or any other suitable fastener. The mounting member 120 may also have another suitable structure in other embodiments, such as a pipe clamp, a vise, a hook, a threaded fastener, or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid dispensing apparatus for use with a bottle, the apparatus comprising a cap, the cap having a top wall and a perimeter wall, the perimeter wall being coupled to and extending away from the top wall, the top wall defining a plurality of holes extending through the top wall, the perimeter wall having internal threads having a shape such that the internal threads are configured for engaging external threads of the bottle.

2. The apparatus of claim 1, further comprising a cover being pivotally coupled to the cap, the cover being movable between an open position and a closed position with respect to the plurality of holes of the top wall.

3. The apparatus of claim 2, further comprising a lip being coupled to the top wall of the cap opposite the perimeter wall, the lip coupling the cover to the cap, the lip extending along a peripheral edge of the top wall, the cover forming a seal with the lip when the cover is in the closed position.

4. The apparatus of claim 3, wherein:
the lip has an inset surface which is inset from an upper surface of the lip, the inset surface being positioned inwardly from the upper surface; and
the cover comprises:
a panel, the panel lying against the inset surface of the lip when the cover is in the closed position; and
a ring being coupled to and extending away from the panel, the ring being positioned in the lip when the cover is positioned in the closed position, the ring being complementary in shape to an interior surface of the lip.

5. The apparatus of claim 3, wherein the cover comprises a panel and a plurality of protrusions, the plurality of protrusions being coupled to and extending away from the panel, the plurality of protrusions plugging the plurality of holes of the top wall of the cap when the cover is positioned in the closed position.

6. The apparatus of claim 2, wherein the cover comprises a panel and a tab, the tab being coupled to and extending away from an exterior edge of the panel.

7. The apparatus of claim 1, further comprising a cover being rotatably coupled to the top wall, the cover comprising a panel defining a plurality of apertures, the cover being positionable in an aligned position wherein the plurality of apertures aligns with the plurality of holes of the top wall of the cap, the cover being positionable in a covered position wherein the panel forms a seal with the top wall of the cap, the plurality of apertures being unaligned with the plurality of holes of the top wall when the cover is positioned in the aligned position.

8. The apparatus of claim 7, wherein the cover further comprises a tab being coupled to and extending away from an exterior edge of the panel.

9. The apparatus of claim 8, further comprising a stop being coupled to the cap, the stop being positioned along a path of movement of the tab such that the stop obstructs the tab to prevent the cover from being positioned in the aligned position, the stop being movable away from the cap to permit the cover to be positioned in the aligned position.

10. The apparatus of claim 9, wherein the stop is removable from the cap.

11. A perforation tool for forming a fluid dispensing apparatus by perforating a cap, the tool comprising:
a collar having an interior dimension such that the collar is configured to extend around a neck of a bottle;
a lever being coupled to the collar, the lever comprising an arm being movable alternately toward and away from the collar;
a cutting member being coupled to the arm of the lever, the cutting member comprising a plurality of spikes, the plurality of spikes pointing toward the collar.

12. The tool of claim 11, wherein the collar comprises a pair of segments which are pivotally interconnected.

13. The tool of claim 12, further comprising a pair of handles, the pair of handles being coupled to the collar, each handle being positioned on an associated segment of the pair of segments opposite a pivot of the collar.

14. The tool of claim 11, wherein the collar defining a groove in an interior side of the collar, the groove having a size such that the groove is configured to receive an outwardly protruding ridge of the bottle.

15. The tool of claim 11, wherein the lever further comprises a track, the track being coupled to the collar and being slidably coupled to the arm, the track defining a channel through which the arm is slidable to move the arm relative to the collar.

16. The tool of claim 11, wherein the cutting member is removable from the arm, the cutting member comprising a disc, the plurality of spikes being coupled to and extending away from the disc, the arm forming a bay for receiving the disc, the plurality of spikes pointing toward the collar when the cutting member is coupled to the arm.

17. A vessel assembly for containing and dispensing a fluid, the assembly comprising:
a bottle defining an interior space therein for containing the fluid, the bottle having a top end and a bottom end, each of the top end and the bottom end being open to the interior space;
a cap coupled to and covering the top end of the bottle, the cap having a top wall and a perimeter wall, the perimeter wall being coupled to and extending away from the top wall, the top wall defining a plurality of holes which extend through the top wall to the interior space of the bottle;
a cover being movably coupled to the cap, the cover being movable between an open position and a closed position with respect to the plurality of holes of the top wall; and
a fluid-receiving member mounted to the bottom end of the bottle, the fluid receiving member having a lower end which faces away from the bottle, the fluid-receiving member defining a basin in the lower end and a channel which is in fluid communication with the basin and the interior space of the bottle; and
a valve mounted to the fluid-receiving member and positioned in the channel, the valve being configured to selectively permit fluid to pass between the basin of the fluid-receiving member and the interior space of the bottle, the valve having an actuator which is movable between an open position and a closed position to alternately open and close the valve respectively.

18. The assembly of claim 17, wherein the fluid-receiving member is removable from the bottle.

19. The assembly of claim 18, wherein the fluid receiving member is threadedly coupled to the bottle.

20. The assembly of claim 17, wherein a bottom side of the actuator is positioned coplanar to the lower end of the fluid-receiving member when in the closed position, the fluid-receiving member protruding away from the bottle past the lower end of the fluid-receiving member when in the open position.
